(19) United States
(12) Patent Application Publication
(10) Pub. No.: US 2025/0299036 A1
(43) Pub. Date: Sep. 25, 2025

(54) ARTIFICIAL NEURAL NETWORK PHOTONIC INTEGRATED CIRCUITS AND METHODS OF FORMATION

(71) Applicant: Taiwan Semiconductor Manufacturing Company, Ltd., Hsinchu (TW)

(72) Inventors: Shinn-Sheng YU, Hsinchu (TW); Yutong WU, Hsinchu City (TW)

(21) Appl. No.: 18/610,867

(22) Filed: Mar. 20, 2024

(51) Int. Cl. G06N 3/067

(52) U.S. Cl. CPC G06N 3/0675

(57) ABSTRACT

Semiconductor photonics devices described herein include three-dimensional photonic integrated circuits that include optical components configured to implement an artificial neural network such as a convolutional neural network (CNN) or a portion thereof. For example, a semiconductor photonics device described herein may include a three-dimensional photonic integrated circuit that includes optical lens structures and spatial light modulator (SLM) structures that are arranged to perform the sub-operations of a convolution operation, including a Fourier transform operation, a multiplication operation, and an inverse Fourier transform operation.

### BACKGROUND

A convolutional neural network (CNN) is a type of artificial neural network designed primarily for processing and analyzing visual data. Visual data may include electronic visual data such as electronic images and videos. CNNs are highly effective in tasks like image recognition, object detection, and even image generation.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of an example of a semiconductor photonics device that includes a photonic integrated circuit described herein.

FIGS. 2A and 2B are diagrams of examples of optical signal propagation through a photonic integrated circuit included in a semiconductor photonics device described herein.

FIGS. 3A-3F are diagrams of an example of forming a semiconductor photonics device (or a portion thereof) described herein.

FIG. 4 is a diagram of an example of a semiconductor photonics device that includes a photonic integrated circuit described herein.

FIG. 5 is a diagram of an example of a semiconductor photonics device that includes a photonic integrated circuit described herein.

FIG. 6 is a diagram of an example of a semiconductor photonics device that includes a photonic integrated circuit described herein.

FIGS. 7A and 7B are diagrams of examples of a semiconductor photonics device that includes a photonic integrated circuit described herein.

FIG. 8 is a diagram of an example of a semiconductor photonics device that includes a photonic integrated circuit described herein.

FIG. 9 is a flowchart of an example process associated with forming a photonic integrated circuit of a semiconductor photonics device described herein.

FIG. 10 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A convolutional neural network (CNN) is made up of various layers, including convolutional layers, pooling layers, and/or fully connected layers, among other examples. For image recognition, an input image may be passed through a series of the convolutional layers to detect features of the input image, such as edges, contours, patterns, and/or textures, among other examples. The pooling layers may be used to down-sample feature maps of the detected features. Max-pooling operations are often performed to down-sample the feature maps. After down-sampling, the feature maps may be processed through the fully connected layers to combine features and to identify classification properties for the input image using activation functions such as softmax and/or rectified linear unit (ReLU) functions, among other examples.

Each convolutional layer may be implemented by a plurality of electronic integrated circuits of a semiconductor device, such as a graphics processing unit (GPU) or an artificial intelligence (AI) accelerator. The electronic integrated circuits are configured to perform a convolution (or correlation) operation of the convolutional layer. A convolution operation involves applying a filter across the input image and using the filter to extract the features of the input image. A convolution operation may include performing a Fourier transform of a plurality of input electrical signals (e.g., that carry data associated with the input image) to generate a plurality of transformed electrical signals. The Fourier transform transforms the input image from the spatial domain to the frequency domain to identify the frequency components of the input image. A multiplication operation of the convolution operation is then performed, in which each frequency component of the transformed electrical signals are multiplied with the filter to modulate the frequency components of the input image based on the frequency response of the filter. The inverse Fourier transform is then performed to transform the output from the multiplication operation back into the spatial domain.

The convolutional operation is a computationally complex operation that typically requires significant processing resources (e.g., a significant quantity of transistors and other types of integrated circuit devices) for the electronic integrated circuits of the semiconductor device. A CNN may include many convolutional layers that each perform one or more convolutional operations for an input. The complexity of artificial neural networks that are used to implement machine learning, deep learning, AI, and other computer-implemented intelligence has increased exponentially in recent years as the use and adoption of computer-implemented intelligence has significantly grown in popularity. In some cases, the computation performance demand for artificial neural networks has doubled approximately every 2-3 months in recent years, and is expected to continue to grow at such a pace (or at an even greater pace). Implementing artificial neural networks with sufficient computational performance for complex computer-implemented intelligence tasks can often times require the use of supercomputers or computational systems having hundreds or thousands of GPUs and/or AI accelerators. The advancements in manufacturing of electronic integrated circuits may not keep pace with the advancement in complexity of computer-implemented intelligence tasks. Even so, the power consumption of such electronic integrated circuits at exascale (or even zettascale) computational performance may be reach power consumption on the order of hundreds to thousands of megawatts.

In some implementations described herein, semiconductor photonics devices include three-dimensional photonic integrated circuits that include optical components configured to implement an artificial neural network such as a CNN or a portion thereof. For example, a semiconductor photonics device described herein may include a three-dimensional photonic integrated circuit that includes optical lens structures and spatial light modulator (SLM) structures that are arranged to perform the sub-operations of a convolution operation, including a Fourier transform operation, a multiplication operation, and an inverse Fourier transform operation.

The use of optical lenses and SLMs to perform these sub-operations of a convolution operation for optical input signals enables these sub-operations to be performed passively by enabling the optical input signals (and associated optical transformed signals) to propagate through the photonic integrated circuit in three dimensions. For example, a first SLM structure may be placed at the front focal plane of a first optical lens structure such that the first SLM structure may provide a modulated optical input signal (e.g., associated with an input image or another type of input) to the first optical lens structure, which passively performs the Fourier transform operation on the modulated optical input signal. A second SLM structure may be placed at the back focal plane of the first optical lens structure to receive the transformed optical signal and to perform the multiplication operation on the transformed optical signal (e.g., based on an optical filter signal) to generate an output optical signal. The output optical signal from the multiplication operation is provided to a second optical lens structure that passively performs the inverse Fourier transform operation on the output optical signal to generate a transformed output optical signal and to provide the transformed output optical signal to one or more optical detectors.

In this way, the three-dimensional photonic integrated circuits described herein enable the use of photons (which have both an amplitude and a phase) to implement encoded optical signals that may be passively transformed for performing complex artificial intelligence tasks. Thus, the photonic integrated circuits described herein consume significantly less power and may be less complex electronic integrated circuits (e.g., a three-dimensional photonic integrated circuit described herein may be capable of processing N optical input signals whereas a semiconductor device may have 2N² electronic integrated circuits for processing N electrical input signals), thereby enabling further scaling of artificial neural networks.

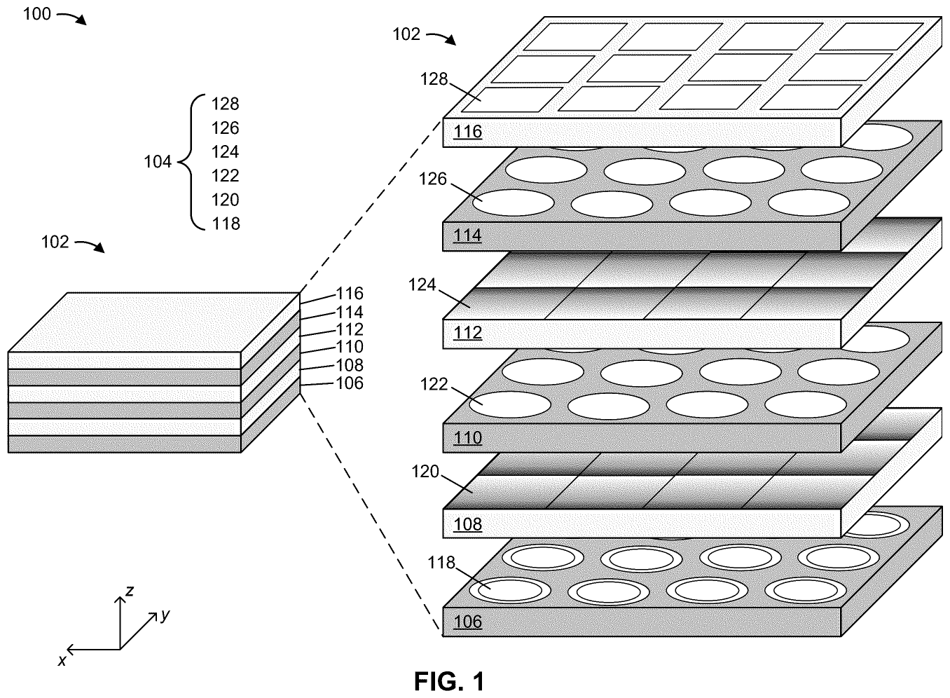

FIG. 1 is a diagram of example 100 of a semiconductor photonics device 102 that includes a photonic integrated circuit 104 described herein. FIG. 1 illustrates a perspective view of the example 100 of semiconductor photonics device 102 and an associated exploded view of the semiconductor photonics device 102 in which the details of the layers of the semiconductor photonics device 102 are illustrated. The photonic integrated circuit 104 includes a portion of an artificial neural network such as a CNN. The photonic integrated circuit 104 may be configured to perform a convolution operation for the CNN. The convolution operation may include a Fourier transform operation, a multiplication operation, and an inverse Fourier operation.

As shown in FIG. 1, semiconductor photonics device 102 may include a layer stack. In some implementations, the layer stack is formed on a substrate. In some implementations, the substrate may include a silicon (Si) substrate, a germanium (Ge) substrate, a binary semiconductor substrate such as a III-V semiconductor substrate or a II-IV semiconductor substrate (e.g., a gallium nitride (GaN) substrate, a gallium arsenide (GaAs) substrate), a silicon carbide (SiC) substrate, and/or another type of semiconductor substrate. In some implementations, a substrate is omitted from the semiconductor photonics device 102.

The layer stack may include a light source layer 106, an SLM layer 108 above the light source layer 106, a lens layer 110 above the SLM layer 108, an SLM layer 112 above the lens layer 110, a lens layer 114 above the SLM layer 112, and a photodetector layer 116 above the lens layer 114. The layers 106-116 may be stacked and arranged in a z-direction (e.g., a vertical direction) in the semiconductor photonics device 102. In some implementations, one or more additional layers are included in the layer stack. For example, one or more buffer layers may be included between two or more of the layers in the layer stack. As another example, one or more polarizer layers may be included between two or more of the layers in the layer stack. As another example, one or more filter layers may be included between two or more of the layers in the layer stack. As another example, one or more phase mask layers may be included between two or more of the layers in the layer stack.

The light source layer 106 may include one or more light source structures 118. The SLM layer 108 may include one or more SLM structures 120 that are formed or placed on an optically transparent substrate. The optically transparent substrate may include silicon oxide (SiOₓ), glass, undoped silica glass (USG), and/or another type optically transparent material. The lens layer 110 may include one or more lens structures 122 that are formed or placed on an optically transparent substrate. The SLM layer 112 may include one or more SLM structures 124 that are formed or placed on an optically transparent substrate. The lens layer 114 may include one or more lens structures 126 that are formed or placed on an optically transparent substrate. The photodetector layer 116 may include one or more photodetector structures 128.

The photonic integrated circuit 104 may include one or more light source structures 118, an SLM structure 120, a lens structure 122, an SLM structure 124, a lens structure 126, and one or more photodetector structures 128 that are stacked or arranged in an z-direction in the semiconductor photonics device 102. The light source structure(s) 118, the SLM structure 120, the lens structure 122, the SLM structure 124, the lens structure 126, and the photodetector structure(s) 128 may correspond to a CNN or a portion thereof, such as a convolutional layer of the CNN. The light source structure(s) 118, the SLM structure 120, the lens structure 122, the SLM structure 124, the lens structure 126, and the photodetector structure(s) 130 are arranged in the z-direction to enable optical signals to propagate from the light source structure(s) 118 to the photodetector structure(s) 128 through the SLM structure 120, the lens structure 122, the SLM structure 124, and the lens structure 126 in the z-direction (e.g., vertically) in the semiconductor photonics device 102. Alternatively, the light source structure(s) 118, the SLM structure 120, the lens structure 122, the SLM structure 124, the lens structure 126, and the photodetector structure(s) 128 are arranged in the x-direction or in the y-direction to enable optical signals to propagate from the light source structure(s) 118 to the photodetector structure(s) 128 through the SLM structure 120, the lens structure 122, the SLM structure 124, and the lens structure 126 in the x-direction or in the y-direction in the semiconductor photonics device 102.

The light source structure(s) 118 may include coherent light source structure(s) (e.g., laser structures) and/or another type of light source structures that are capable of generating coherent optical signals (e.g., laser signals). Examples of such light source structure(s) include semiconductor lasers (e.g., semiconductor laser diodes) such as edge-emitting diode lasers, quantum well lasers, and/or vertical cavity surface emitting laser (VCSEL) structures, among other examples. In some implementations, one or more of the light source structure(s) 118 are configured to generate one or more optical input signals associated with an input (e.g., an input image) to the convolutional layer of the photonic integrated circuit 104. In some implementations, one or more of the light source structure(s) 118 are configured to generate one or more optical filter signals associated with a filter that is to be applied by the convolutional layer of the photonic integrated circuit 104. In some implementations, a light source structure 118 is configured to generate an expanded light beam from a signal laser source. In some implementations, a plurality of light source structures 118 are configured to generate an array of laser signals that are phase-locked by a single leader laser.

In some implementations, the light source structure(s) 118 each include one or more semiconductor materials such as silicon (Si), silicon germanium (SiGe), gallium arsenide (GaAs), indium phosphide (InP), gallium nitride (GaN), aluminum gallium arsenide (AlGaAs), indium gallium nitride (InGaN), and/or quantum dot semiconductor materials, among other examples. In some implementations, a light source structure 118 includes a P-N junction between a p-type semiconductor layer and an n-type semiconductor layer. The p-type semiconductor layer may include a semiconductor material (e.g., silicon (Si)) that is doped with one or more p-type dopants such as boron (B), aluminum (Al), and/or gallium (Ga), among other examples. The n-type semiconductor layer may include a semiconductor material (e.g., silicon (Si)) that is doped with one or more n-type dopants such as phosphorous (P), arsenic (As), and/or antimony (Sb), among other examples.

The SLM structure 120 is located at a front focal plane of the lens structure 122 in the z-direction. The SLM structure 120 may extend in an x-y plane such that a first surface of the SLM structure 120 is facing the light source structures 118 in the light source layer 106, and a second (opposing) surface of the SLM structure 120 is facing the lens structure 122 in the lens layer 110.

The SLM structure 120 is configured to receive one or more optical input signals from the light source structure(s) 118 and to generate complex-valued optical input signals for the input to the CNN. The complex-valued optical input signals may include a plurality of modulated optical input signals for generating feature maps associated with the input to the

CNN. The SLM structure 120 includes a transmissive SLM structure that permits optical signals to pass (or be transmitted) through the SLM structure 120. Since the photons of the optical input signals received from the light source structure(s) 118 have both amplitude and phase, the SLM structure 120 is capable of generating the modulated optical input signals based on the amplitude and phase of the optical input signals. In particular, the SLM structure 120 is configured to modulate both the amplitude and the phase of the optical input signals to generate the modulated optical input signals.

In some implementations, the SLM structure 120 includes a plurality of layers and/or structures that include semiconductor materials, metal materials, dielectric materials, and/or liquid-crystal material, among other examples. For example, the SLM structure 120 may include a semiconductor layer (e.g., a silicon-based layer) in which control electronics of the SLM structure 120 are included. As another example, the SLM structure 120 may include one or more electrodes, liquid crystal layers, and/or dielectric passivation layer, among other examples. The control circuitry in the semiconductor layer may be configured to control the refractive index in the liquid crystal layers, thereby enabling the optical input signals to be modulated. The electrodes may include one or more metals such as tungsten (W), cobalt (Co), ruthenium (Ru), titanium (Ti), aluminum (Al), copper (Cu) or gold (Au), another metal, and/or an alloy thereof. The dielectric passivation layer may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material.

The modulated optical input signals may propagate from the SLM structure 120 toward the lens structure 122 in the z-direction in the semiconductor photonics device 102. Moreover, the optical input signals may be spatially distributed in the x-direction and in the y-direction in the semiconductor photonics device 102. Thus, the modulated optical input signals propagate through the photonic integrated circuit 104 in three dimensions, enabling the lens structure 122 to passively perform (e.g., without an electrical input) a Fourier transform of the modulated optical input signals.

The lens structure 122 is located between the SLM structure 120 and the SLM structure 124 in the z-direction. As indicated above, the lens structure 122 is configured to passively perform a Fourier transform of the modulated optical input signals to generate transformed optical signals. The lens structure 122 may extend in an x-y plane such that a first surface of the lens structure 122 is facing the SLM structure 120 in the SLM layer 108, and a second (opposing surface) of the lens structure 122 is facing the SLM structure 124 in the SLM layer 112. The lens structure 122 may include a semiconductor lens (e.g., a silicon (Si)), a dielectric lens (e.g., a silicon oxide (SiOₓ) lens and/or a lens formed of another optically transparent dielectric material), and/or another type of lens structure. The lens may be convex, plano-convex, biconvex, biconcave, concave, and/or another lens shape. In some implementations, a plurality of lens structures 122 are included between the SLM structure 120 and the SLM structure 124 for performing the Fourier transform.

The SLM structure 124 is located at a back focal plane of the lens structure 122 in the z-direction and at a front focal plane of the lens structure 126 in the z-direction. The SLM structure 124 may extend in an x-y plane such that a first surface of the SLM structure 124 is facing the lens structure 122 in the lens layer 110, and a second (opposing surface) of the SLM structure 124 is facing the lens structure 126 in the lens layer 114.

The SLM structure 124 is configured to receive the transformed optical signals from the lens structure 122 and to modulate the transformed optical signals to generate output optical signals. In particular, the SLM structure 124 is configured to perform the multiplication operation of the CNN, which may include modulating the transformed optical signals based on the transformed filter optical signals (e.g., the space-inverted filter).

The SLM structure 124 includes a transmissive SLM structure that permits optical signals to pass (or be transmitted) through the SLM structure 124. In some implementations, the SLM structure 124 includes a plurality of layers and/or structures that include semiconductor materials, metal materials, dielectric materials, and/or liquid-crystal material, among other examples. For example, the SLM structure 124 may include a semiconductor layer (e.g., a silicon-based layer) in which control electronics of the SLM structure 124 are included. As another example, the SLM structure 124 may include one or more electrodes, liquid crystal layers, and/or dielectric passivation layer, among other examples. The control circuitry in the semiconductor layer may be configured to control the refractive index in the liquid crystal layers, thereby enabling the transformed optical signals to be modulated. The electrodes may include one or more metals such as tungsten (W), cobalt (Co), ruthenium (Ru), titanium (Ti), aluminum (Al), copper (Cu) or gold (Au), another metal, and/or an alloy thereof. The dielectric passivation layer may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material.

The output optical signals may propagate from the SLM structure 124 toward the lens structure 126 in the z-direction in the semiconductor photonics device 102. Moreover, the optical input signals may be spatially distributed in the y-direction and in the x-direction in the semiconductor photonics device 102. Thus, the output optical signals propagate through the photonic integrated circuit 104 in three dimensions, enabling the lens structure 126 to passively perform (e.g., without an electrical input) an inverse Fourier transform of the complex-valued optical input signals.

The lens structure 126 is located between the SLM structure 126 and the photodetector structure(s) 128. As indicated above, the lens structure 126 is configured to passively perform an inverse Fourier transform of the optical output signals to generate transformed optical output signals. The lens structure 126 may extend in an x-y plane such that a first surface of the lens structure 126 is facing the SLM structure 124 in the SLM layer 112, and a second (opposing surface) of the lens structure 126 is facing the photodetector structure(s) 128 in the photodetector layer 116. The lens structure 126 may include a semiconductor lens (e.g., a silicon (Si)), a dielectric lens (e.g., a silicon oxide (SiOₓ) lens and/or a lens formed of another optically transparent dielectric material), and/or another type of lens structure. The lens structure 126 may be convex, plano-convex, biconvex, biconcave, concave, and/or another lens shape. In some implementations, a plurality of lens structures 126 are included between the SLM structure 124 and the photodetector structure(s) 128 for performing the inverse Fourier transform.

The photodetector structure(s) 128 are located at a back focal plane of the lens structure 126 in the z-direction and may be configured to receive the transformed optical output signals from the lens structure 126. The photodetector structure(s) 128 may include semiconductor photodetector structures that are capable of generating an electrical signal based on the transformed optical output signals. In some implementations, the photonic integrated circuit 104 includes a plurality of photodetector structures 128 that are arranged as an array in a y-direction and/or in an x-direction in the semiconductor photonics device 102. In some implementations, each photodetector structure 128 is configured to receive an associated transformed optical output signal and to generate an electrical signal based on the transformed optical output signal (e.g., based on an intensity or amplitude of the transformed optical output signal). In some implementations, a feature map of the input may be encoded on the electrical signal.

In some implementations, the photodetector structure(s) 128 each include a P-N junction diode, a P-I-N junction diode (e.g., a diode that includes a p-type semiconductor material/intrinsic semiconductor material/n-type semiconductor material junction), and/or another type of semiconductor structure that is capable of generating an electrical signal (referred to as a photocurrent) based on photons received in an optical signal. Photons generate electron/hole pairs in an absorption region (the intrinsic semiconductor material) of a photodetector structure 128, and electrons and holes are separated and collected at opposing doped collection regions (the p-type and n-type semiconductor materials).

Thus, the photonic integrated circuit 104 includes an SLM structure 120, a lens structure 122 adjacent to the SLM structure 124 in the z-direction, an SLM structure 124 adjacent to the lens structure 122 in the z-direction (the lens structure 122 being located is between the SLM structure 120 and the SLM structure 124 in the z-direction), and a lens structure 126 adjacent to the SLM structure 124 in the z-direction. The light source structure(s) 118 may be located adjacent to the SLM structure 120 in the z-direction such that the SLM structure 120 is between the light source structure(s) 118 and the lens structure 122 in the z-direction. The photodetector structure(s) 128 may be located adjacent to the lens structure 126 in the z-direction such that the lens structure 126 is between the photodetector structure(s) 128 and the SLM structure 124 in the z-direction.

The SLM structures 120 and/or 126 may each include a transmissive SLM structure through which optical signals may pass. The lens structure 122 and the lens structure 126 form a 4f optical system (e.g., a 4 focal point optical system), in which the SLM structure 120 is located at a front focal plane of the lens structure 122, the SLM structure 124 is located at a back focal plane of the lens structure 122 and at a front focal plane of the lens structure 126, and the photodetector structure(s) 128 are located at a back focal plane of the lens structure 126.

As indicated above, FIG. 1 is provided as an example. Other examples may differ from what is described with regard to FIG. 1.

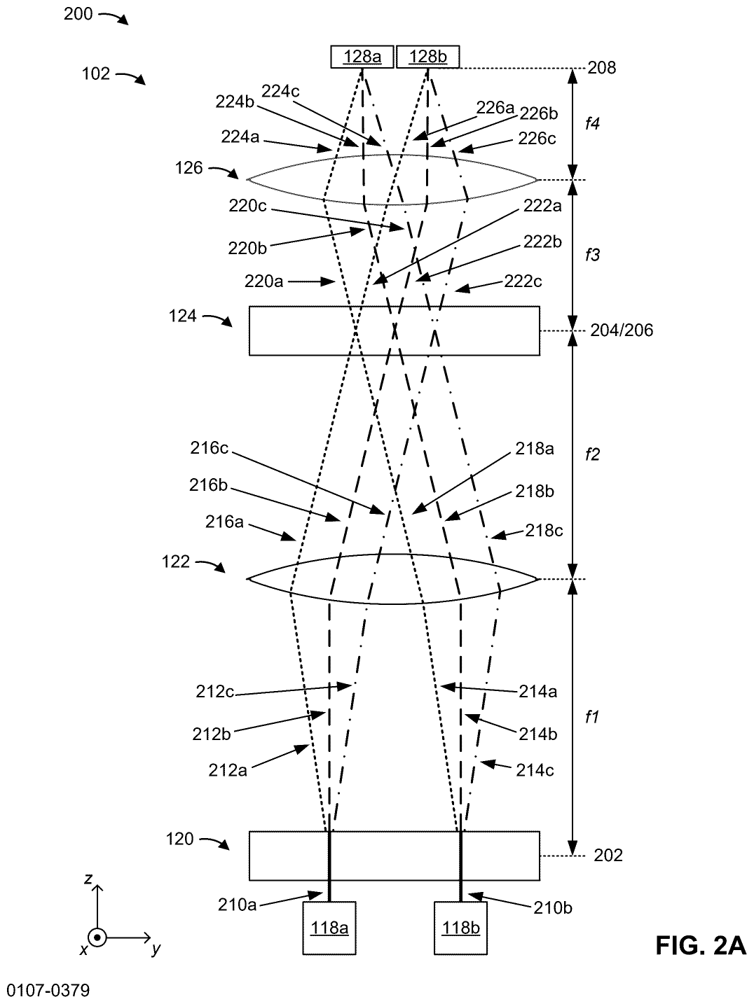

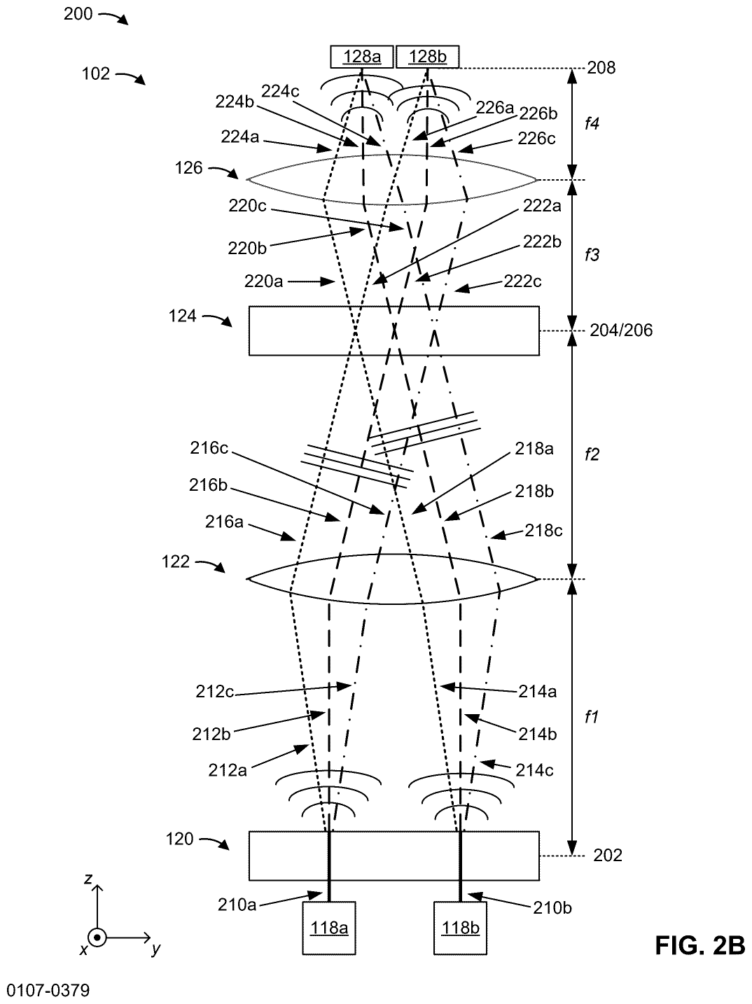

FIGS. 2A and 2B are diagrams of an example 200 of optical signal propagation through the photonic integrated circuit 104 included in the semiconductor photonics device 102 described herein. FIG. 2A illustrates a side view of the photonic integrated circuit 104 included in the semiconductor photonics device 102. As shown in FIG. 2A, an SLM structure 120 from the SLM layer 108, a lens structure 122 from the lens layer 110, an SLM structure 124 from the SLM layer 112, and a lens structure 126 from the lens layer 114 are arranged in the z-direction (e.g., a vertically arranged) in the semiconductor photonics device 102, which enables optical signals to propagate through and between the SLM structure 120, the lens structure 122, the SLM structure 124, and the lens structure 126 in the z-direction in the semiconductor photonics device 102. The photonic integrated circuit 104 may further include a plurality of light source structures 118a and 120b from the light source layer 106, and a plurality of photodetector structures 128a and 128b from the photodetector layer 116. The quantity of the light source structures 118a and 120b and the quantity of the photodetector structures 128a and 128b illustrated in FIG. 2A is an example, and other quantities of light source structures and other quantities of photodetector structures are within the scope of the present disclosure.

As indicated above, the SLM structure 120, the lens structure 122, the SLM structure 124, and the lens structure 126 are arranged in a 4f system that includes four focal planes 202, 204, 206, and 208. The focal plane 202 corresponds to a location of the SLM structure 120 and is a front focal plane of the lens structure 122 in the z-direction. The focal plane 204 corresponds to a location of the SLM structure 124 and is a back focal plane of the lens structure 122 in the z-direction. The focal plane 206 also corresponds to the location of the SLM structure 124 and is a front focal plane of the lens structure 126 in the z-direction. The focal plane 208 corresponds to a location of the photodetector structure(s) 128 and is a back focal plane of the lens structure 126 in the z-direction. The focal plane 202 may correspond to an object plane of the 4f system, the focal planes 204 and 206 may correspond to a pupil plane of the 4f system, and the focal plane 208 may correspond to an image plane of the 4f system.

The SLM structure 120 and the lens structure 122 may be spaced apart in the z-direction by a focal distance f1. The SLM structure 124 and the lens structure 122 may be spaced apart in the z-direction by a focal distance f2. The SLM structure 124 and the lens structure 126 may be spaced apart in the z-direction by a focal distance f3. The lens structure 126 and the photodetector structures 128a and 128b may be spaced apart in the z-direction by a focal distance f4. In some implementations, the focal distance f1 and the focal distance f2 are approximately equal. In some implementations, the focal distance f1 and the focal distance f2 are different focal distances. In some implementations, the focal distance f1 is greater than each of the focal distances f3 and f4. In some implementations, the focal distance f2 is greater than each of the focal distances f3 and f4. In some implementations, the combined focal distance of the focal distances f1 and f2 is greater than the combined focal distance of the focal distances f3 and f4. In some implementations, the focal distance f3 and the focal distance f4 are approximately equal. In some implementations, the focal distance f3 and the focal distance f4 are different focal distances.

As further shown in the example 200 in FIG. 2A, the light source structures 118a and 120b may each generate a respective optical input signals 210a and 210b. The optical input signals 210a and 210b may propagate toward the SLM structure 120 in the z-direction. The optical input signals 210a and 210b may also propagate in the x-direction and/or in the y-direction in the semiconductor photonics device 102. The quantity of optical input signals 210a and 210b illustrated in FIG. 2A is an example, and other quantities of optical input signals are within the scope of the present disclosure.

The optical input signals 210a and 210b may pass through the SLM structure 120, and the SLM structure 120 may modulate the optical input signals 210a and 210b to generate a plurality of modulated optical input signals 212a-212c and a plurality of optical filter signals 214a-214c. The modulated optical input signals 212a-212c and the optical filter signals 214a-214c may propagate toward the lens structure 122 in the z-direction. The modulated optical input signals 212a-212c and the optical filter signals 214a-214c may also propagate in the x-direction and in the y-direction in the semiconductor photonics device 102. The quantity of modulated optical input signals 212a-212c and the quantity of optical filter signals 214a-214c illustrated in FIG. 2A are examples, and other quantities of modulated optical input signals and other quantities of optical filter signals are within the scope of the present disclosure.

The modulated optical input signals 212a-212c and the optical filter signals 214a-214c may be received at the lens structure 122, and the lens structure 122 may perform a Fourier transform of the modulated optical input signals 212a-212c and the optical filter signals 214a-214c. This results in the lens structure 122 generating transformed optical signals 216a-216c from the modulated optical input signals 212a-212c and transformed optical filter signals 218a-218c from the modulated optical filter signals 214a-214c. The quantity of transformed optical signals 216a-216c and the quantity of transformed optical filter signals 218a-218c illustrated in FIG. 2A are examples, and other quantities of transformed optical signals and other quantities of transformed optical filter signals are within the scope of the present disclosure.

The transformed optical signals 216a-216c and the transformed optical filter signals 218a-218c propagate from the lens structure 122 to the SLM structure 124 in the z-direction in the semiconductor photonics device 102. The transformed optical signals 216a-216c and the transformed optical filter signals 218a-218c also propagate in the x-direction and/or in the y-direction in the semiconductor photonics device 102.

The transformed optical signals 216a-216c and the transformed optical filter signals 218a-218c may pass through the SLM structure 124, and the SLM structure 124 may perform a multiplication operation to modulate the transformed optical signals 216a-216c based on the transformed optical filter signals 218a-218c. For example, the transformed optical signal 216a may be multiplied with the transformed optical filter signal 218a, the transformed optical signal 216b may be multiplied with the transformed optical filter signal 218b, the transformed optical signal 216c may be multiplied with the transformed optical filter signal 218c, and so on. This results in the SLM structure 124 generating a plurality of modulated optical output signals 220a-220c and a plurality of modulated optical output signals 222a-222c. The modulated optical output signals 220a-220c and the modulated optical output signals 222a-222c may propagate toward the lens structure 126 in the z-direction. The modulated optical output signals 220a-220c and the modulated optical output signals 222a-222c may also propagate in the x-direction and/or in the y-direction in the semiconductor photonics device 102. The quantity of modulated optical output signals 220a-220c and the quantity of modulated optical output signals 222a-222c illustrated in FIG. 2A are examples, and other quantities of modulated optical output signals are within the scope of the present disclosure.

The modulated optical output signals 220a-220c and 222a-222c may be received at the lens structure 126, and the lens structure 126 may perform an inverse Fourier transform of the modulated optical output signals 220a-220c and 222a-222c. This results in the lens structure 126 generating transformed optical output signals 224a-224c from the modulated optical output signals 220a-220c and transformed optical output signals 226a-226c from the modulated optical output signals 222a-222c. The quantity of transformed optical output signals 224a-224c and the quantity of transformed optical output signals 226a-226c illustrated in FIG. 2A are examples, and other quantities of transformed optical output signals are within the scope of the present disclosure.

The transformed optical output signals 224a-224c may propagate to the photodetector structure 128a in the z-direction, and the transformed optical output signals 226a-226c may propagate to the photodetector structure 128b in the z-direction in the semiconductor photonics device 102. The transformed optical output signals 224a-224c and 226a-226c may also propagate in the x-direction and/or in the y-direction in the semiconductor photonics device 102. The photodetector structure 128a may generate electrical output signals based on the transformed optical output signals 224a-224c, and the photodetector structure 128b may generate electrical output signals based on the transformed optical output signals 226a-226c.

As shown in FIG. 2B, the components of the photonic integrated circuit 104 may transform optical signals between various types of waves. For example, the lens structure 122 may transform spherical waves of the modulated optical input signals 212a-212c and spherical waves of the optical filter signals 214a-214c to plane waves of the transformed optical signals 216a-216c and plane waves of the transformed optical filter signals 218a-218c, respectively. As another example, the lens structure 126 may transform plane waves of the modulated optical output signals 220a-220c and 222a-222c to spherical waves of the transformed optical output signals 224a-224c and 226a-226c, respectively.

As indicated above, FIGS. 2A and 2B are provided as examples. Other examples may differ from what is described with regard to FIGS. 2A and 2B.

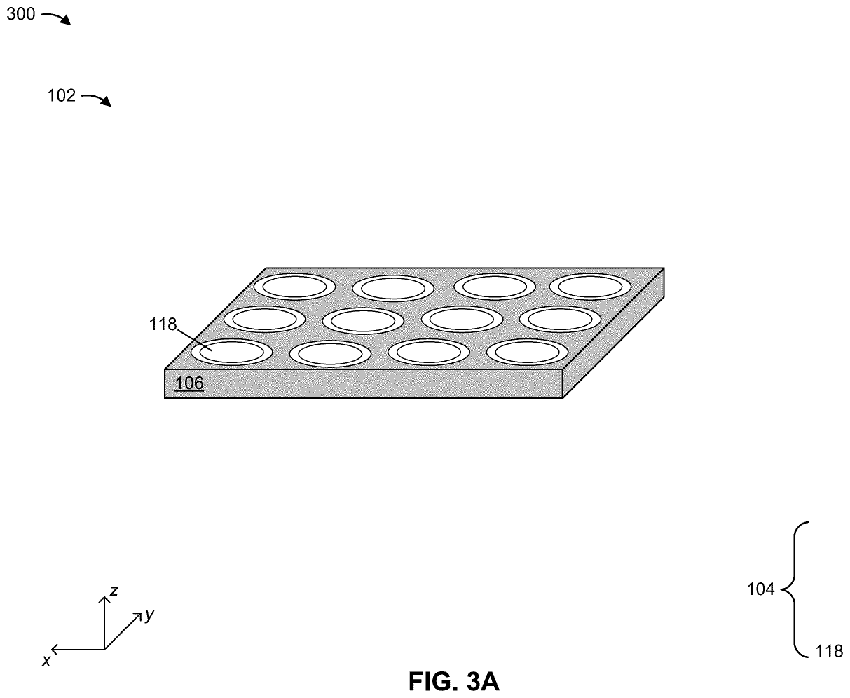

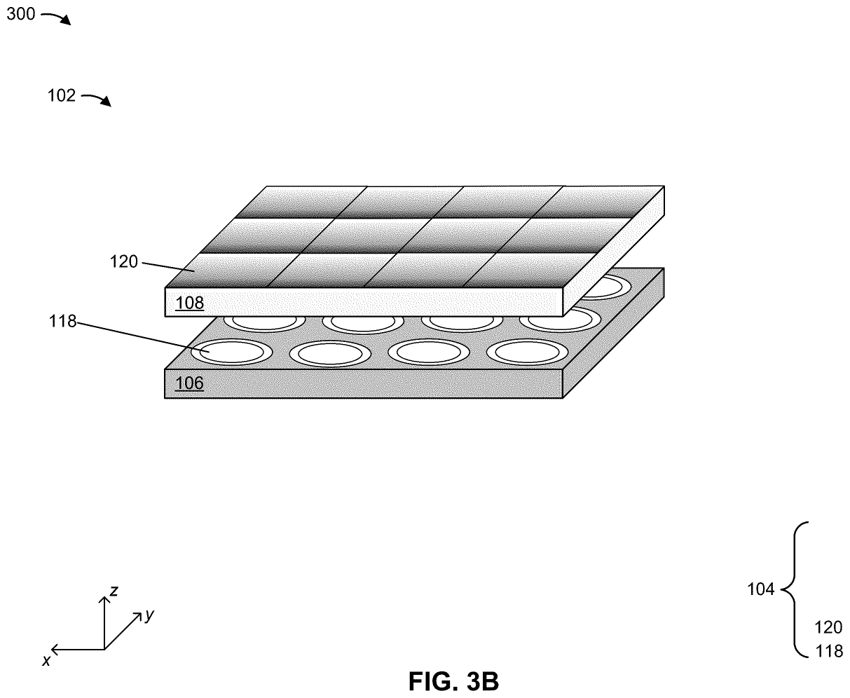

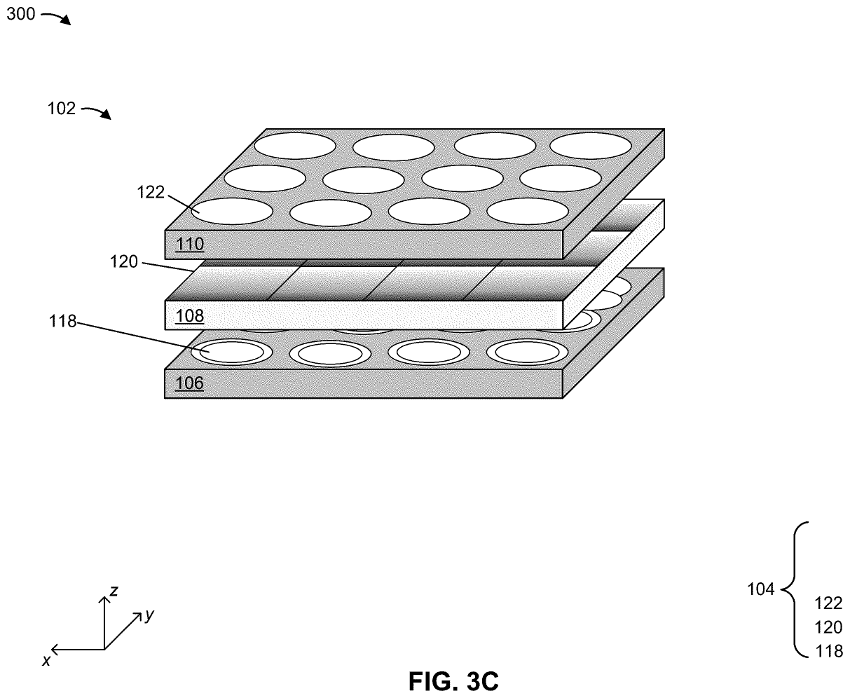

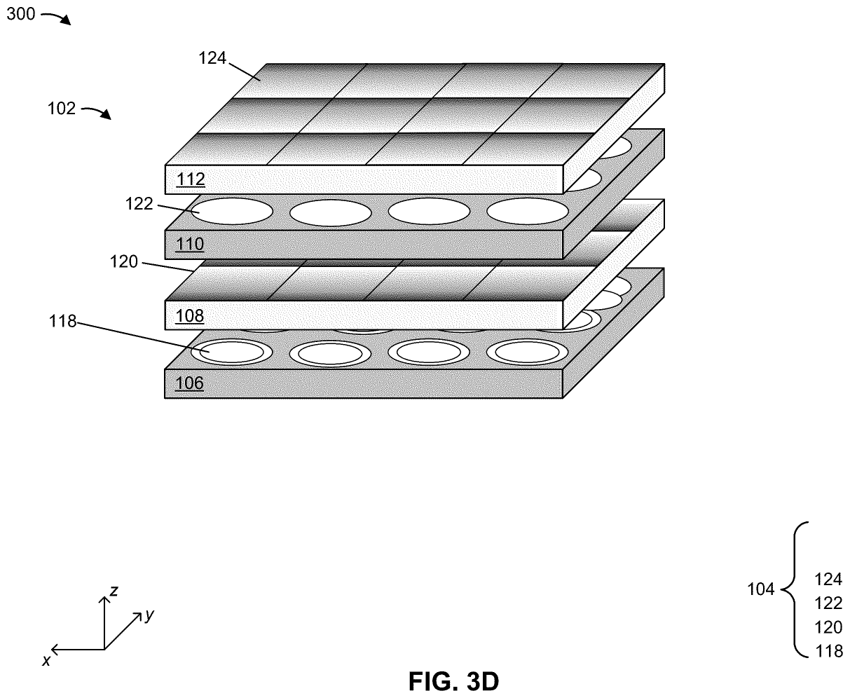

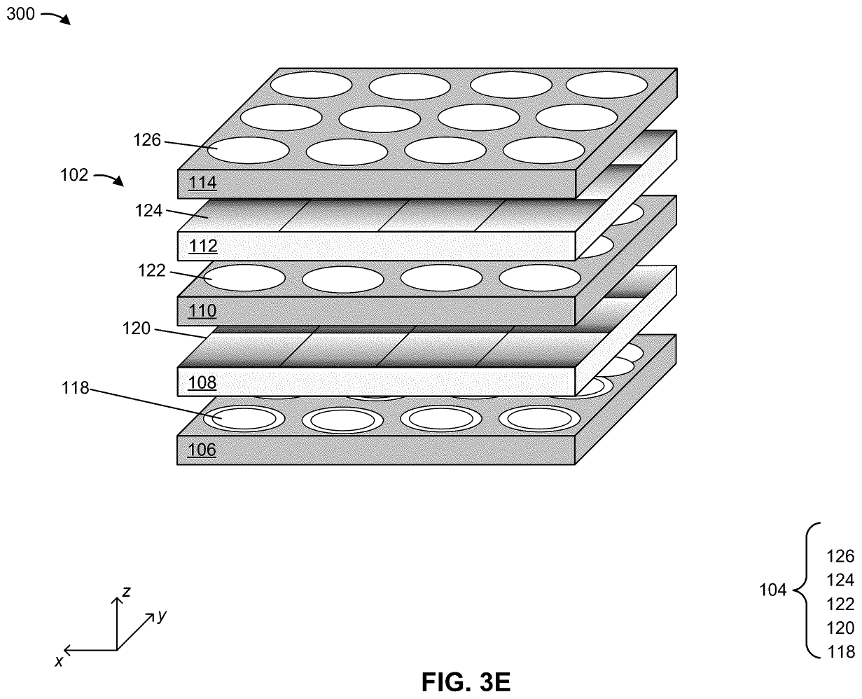

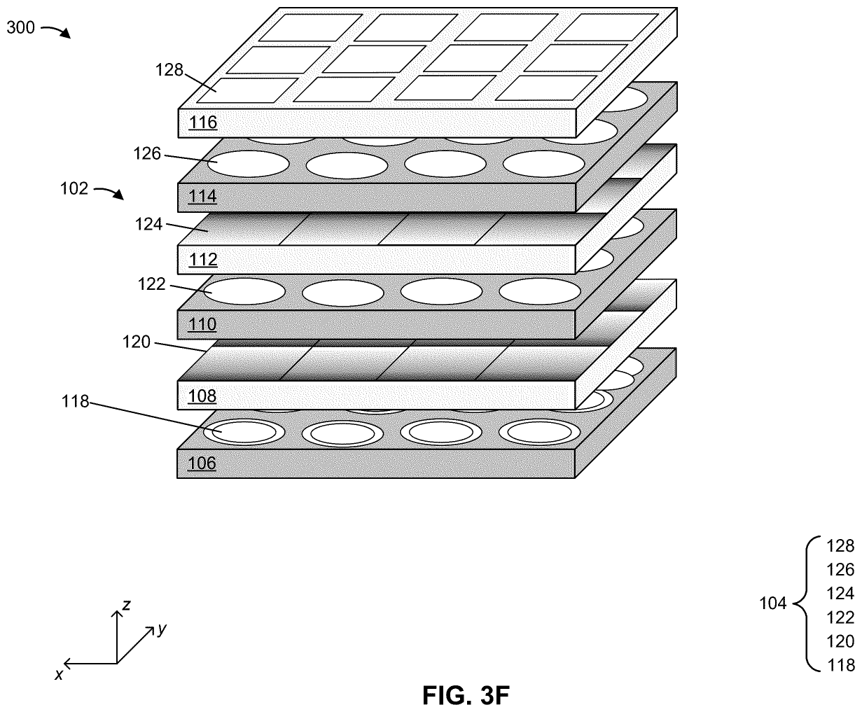

FIGS. 3A-3F are diagrams of an example 300 of forming the semiconductor photonics device 102 (or a portion thereof) described herein. In particular, the example 300 includes an example of forming the photonic integrated circuit 104 in the semiconductor photonics device 102. In some implementations, one or more of the semiconductor processing operations described in connection with FIGS. 3A-3F are performed using one or more semiconductor processing tools, such as a deposition tool, an exposure tool, a developer tool, an etch tool, a plating tool, a planarization tool, an ion implantation tool, a wafer/die transport tool, and/or another type of semiconductor processing tool.

In some implementations, the photonic integrated circuit 104 of the semiconductor photonics device 102 may be formed on and/or above the substrate. In some implementations, one or more components of the photonic integrated circuit 104 may be provided or placed on a substrate. The substrate may be provided in the form of a wafer, a die, and/or another type of workpiece. Alternatively, the substrate may be provided as a carrier wafer, a handle wafer, a semiconductor die frame, and/or another type of substrate. For example, the substrate may include a silicon on insulator (SOI) wafer, a dielectric wafer, a semiconductor wafer (e.g., a silicon wafer), and/or another type of wafer. As another example, the substrate may include an SOI die, a dielectric die, a semiconductor die (e.g., a silicon die), and/or another type of die. As another example, the substrate may include a removable substrate, such as a carrier wafer, a handle wafer, a die frame, a die holder, a die carrier, and/or another type of removable or temporary substrate.

As shown in FIG. 3A, one or more of the light source structure(s) 118 of the photonic integrated circuit 104 may be manufactured in a light source layer 106, and the light source layer 106 (along with the light source structure(s) 118 formed thereon) be provided. For example, the light source layer 106 may be provided above a substrate.

As shown in FIG. 3B, a SLM structure 120 of the photonic integrated circuit 104 may be manufactured in an SLM layer 108, and the SLM layer 108 (along with the SLM structures 120 formed thereon) may be placed on or over the light source layer 106. In some implementations, the SLM structures 120 are manufactured in or placed on a transparent substrate of the SLM layer 108.

As shown in FIG. 3C, a lens structure 122 of the photonic integrated circuit 104 may be manufactured in a lens layer 110, and the lens layer 110 (along with the lens structures 122 formed thereon) may be placed on or over the SLM layer 108. In some implementations, the lens structures 122 may be manufactured in or placed on a transparent substrate of the lens layer 110.

As shown in FIG. 3D, a SLM structure 124 of the photonic integrated circuit 104 may be manufactured in an SLM layer 112, and the SLM layer 112 (along with the SLM structures 124 formed thereon) may be placed on or over the lens layer 110. In some implementations, the SLM structures 124 are manufactured in or placed on a transparent substrate of the SLM layer 112.

As shown in FIG. 3E, a lens structure 126 of the photonic integrated circuit 104 may be manufactured in a lens layer 114, and the lens layer 114 (along with the lens structures 126 formed thereon) may be placed on or over the SLM layer 112. In some implementations, the lens structures 126 may be manufactured in or placed on a transparent substrate of the lens layer

As shown in FIG. 3F, one or more photodetector structures 128 of the photonic integrated circuit 104 may be manufactured in a photodetector layer 116, and the photodetector layer 116 (along with the photodetector structures 128 formed thereon) may be placed on or over the lens layer 114. In some implementations, the photodetector structures 128 may be manufactured in or placed on a transparent substrate of the photodetector layer 116.

In some implementations, one or more of the light source structure(s) 118, the SLM structure 120, the lens structure 122, the SLM structure 124, the lens structure 126, and/or the photodetector structure(s) 128 may be provided after partial manufacturing, and manufacturing may be completed for these component(s) after being provided.

In some implementations, one or more components of the photonic integrated circuit 104 may be formed from a semiconductor layer, such as the light source structure(s) 118, the SLM structure 120, the lens structure 122, the SLM structure 124, the lens structure 126, and/or the photodetector structure(s) 128. For example, a hard mask layer may be formed over and/or on the semiconductor layer, and a pattern in the hard mask layer may be used to etch the semiconductor layer to remove portions of the semiconductor layer based on the pattern to form the light source structure(s) 118, the SLM structure 120, the lens structure 122, the SLM structure 124, the lens structure 126, and/or the photodetector structure(s) 128.

Deposition tools may be used to deposit the hard mask layer on the semiconductor layer (e.g., using a chemical vapor deposition (CVD) technique, a physical vapor deposition (PVD) technique, and/or another type of deposition technique) and a photoresist layer on the hard mask layer (e.g., using a spin-coating technique and/or another type of deposition technique). The hard mask layer may include a silicon nitride (SiₓN_{y} such as Si₃N₄) material or another hard mask material. The photoresist layer may include a light-sensitive material that can be patterned using an exposure tool such as a deep ultraviolet (DUV) lithography tool and/or an extreme ultraviolet (EUV) lithography tool, among other examples. An exposure tool may be used to expose the photoresist layer to a radiation source to form a pattern in the photoresist layer. A developer tool may be used to develop and remove portions of the photoresist layer to expose the pattern. An etch tool may be used to etch the hard mask layer to transfer the pattern from the photoresist layer to the hard mask layer. An etch tool may then be used to etch the semiconductor layer based on the pattern in the hard mask layer to remove material from the semiconductor layer to form the pattern to form the light source structure(s) 118, the SLM structure 120, the lens structure 122, the SLM structure 124, the lens structure 126, and/or the photodetector structure(s) 128. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique).

In some implementations, one or more portions of the light source structure(s) 118, one or more portions of the SLM structure 120, one or more portions of the lens structure 122, one or more portions of the SLM structure 124, one or more portions of the lens structure 126, and/or one or more portions of the photodetector structure(s) 128 are formed from the semiconductor layer. Additional portions of the light source structure(s) 118, additional portions of the SLM structure 120, additional portions of the lens structure 122, additional portions of the SLM structure 124, additional portions of the lens structure 126, and/or additional of the photodetector structure(s) 128 may be formed from other layers and/or structures in the semiconductor photonics device 102.

As shown in FIG. 3F, the light source layer 106, the SLM layer 108, the lens layer 110, the SLM layer 112, the lens layer 114, and the photodetector layer 116 of the semiconductor photonics device 102 may be formed such that the light source structure(s) 118, the SLM structure 120, the lens structure 122, the SLM structure 124, the lens structure 126, and the photodetector structure(s) 128 of the photonic integrated circuit 104 are arranged in the z-direction in the semiconductor photonics device 102.

As indicated above, FIGS. 3A-3F are provided as an example. Other examples may differ from what is described with regard to FIGS. 3A-3F.

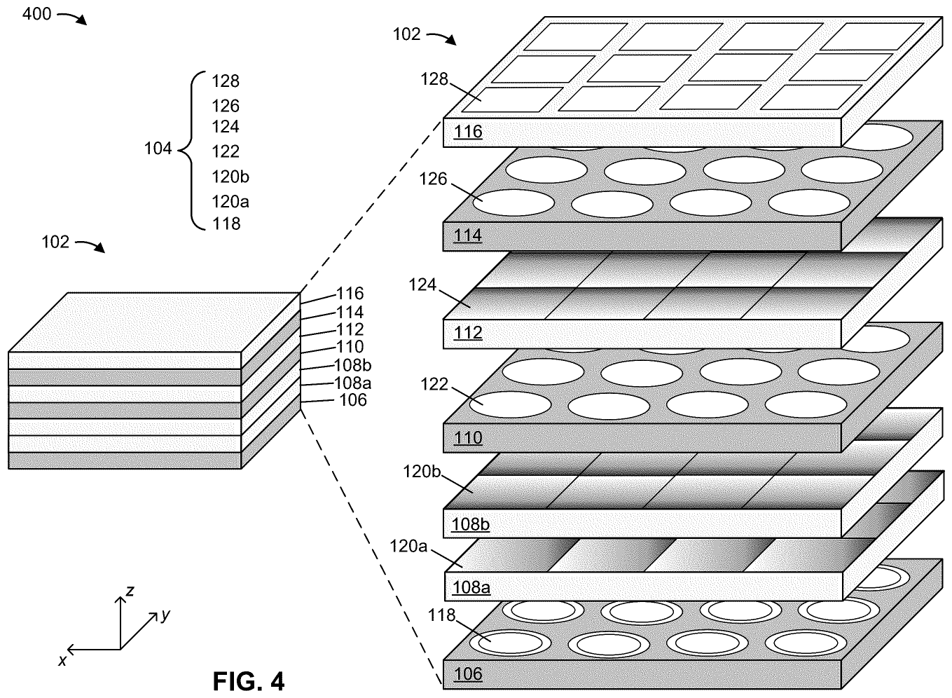

FIG. 4 is a diagram of example 400 of a semiconductor photonics device 102 that includes a photonic integrated circuit 104 described herein. FIG. 4 illustrates a perspective view of the example 400 of semiconductor photonics device 102 and an associated exploded view of the semiconductor photonics device 102 in which the details of the layers of the semiconductor photonics device 102 are illustrated. The photonic integrated circuit 104 includes a portion of an artificial neural network such as a CNN. The photonic integrated circuit 104 may be configured to perform a convolution operation for the CNN. The convolution operation may include a Fourier transform operation, a multiplication operation, and an inverse Fourier operation.

As shown in FIG. 4, in the example 400, the semiconductor photonics device 102 includes a layer stack similar to the example 100 in FIG. 1, except that the semiconductor photonics device 102 includes a plurality of SLM layers 108a and 108b between the light source layer 106 and the lens layer 110 in the z-direction. Accordingly, in the example 400, the photonic integrated circuit 104 includes a plurality of SLM structure components 120a and 120b between the light source structure(s) 118 and the lens structure 122 in the z-direction. The SLM structure component 120a may be adjacent (e.g., vertically adjacent) to the light source structure(s) 118 in the z-direction, and the SLM structure component 120b may be adjacent (e.g., vertically adjacent) to the lens structure 122 in the z-direction.

The SLM structure components 120a and 120b may be configured to perform respective functions for modulating the optical input signals received from the light source structure(s) 118. For example, the SLM structure component 120a may include a transmissive phase-only SLM structure that is configured to perform phase modulation of the optical input signals, and the SLM structure component 120b may include a transmissive amplitude SLM (e.g., an amplitude modulation SLM structure component) configured to perform amplitude modulation of the optical input signals. The combined phase and amplitude modulation performed by the SLM structure components 120a and 120b enable the modulated optical input signals to be generated. In some implementations, the SLM structure component 120b (e.g., the amplitude SLM) includes a transmissive phase-only SLM combined with one or more polarizers.

As indicated above, FIG. 4 is provided as an example. Other examples may differ from what is described with regard to FIG. 4.

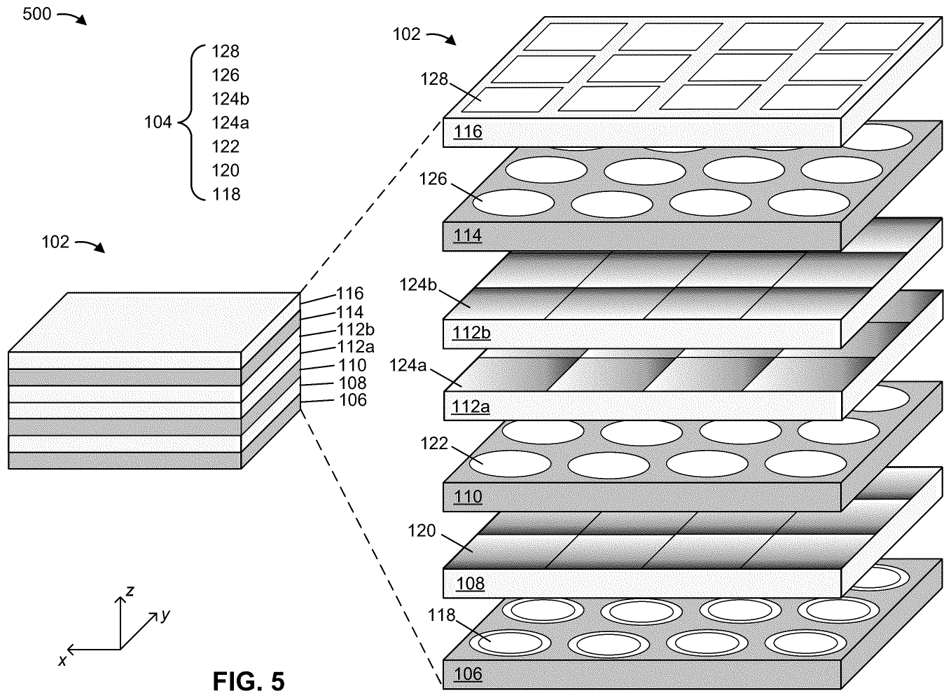

FIG. 5 is a diagram of example 500 of a semiconductor photonics device 102 that includes a photonic integrated circuit 104 described herein. FIG. 5 illustrates a perspective view of the example 500 of semiconductor photonics device 102 and an associated exploded view of the semiconductor photonics device 102 in which the details of the layers of the semiconductor photonics device 102 are illustrated. The photonic integrated circuit 104 includes a portion of an artificial neural network such as a CNN. The photonic integrated circuit 104 may be configured to perform a convolution operation for the CNN. The convolution operation may include a Fourier transform operation, a multiplication operation, and an inverse Fourier operation.

As shown in FIG. 5, in the example 500, the semiconductor photonics device 102 includes a layer stack similar to the example 100 in FIG. 1, except that the semiconductor photonics device 102 includes a plurality of SLM layers 112a and 112b between the lens layer 110 and the lens layer 114 in the z-direction. Accordingly, in the example 500, the photonic integrated circuit 104 includes a plurality of SLM structure components 124a and 124b between the lens structure 122 and the lens structure 126 in the z-direction. The SLM structure component 124a may be adjacent to the lens structure 122 in the z-direction, and the SLM structure component 124b may be adjacent to the lens structure 126 in the z-direction.

The SLM structure components 124a and 124b may be configured to perform respective functions for modulating the transformed optical signals received from the lens structure 122. For example, the SLM structure component 124a may include a transmissive phase-only SLM structure that is configured to perform phase modulation of the transformed optical signals, and the SLM structure component 124b may include a transmissive amplitude SLM (e.g., an amplitude modulation SLM structure component) configured to perform amplitude modulation of the transformed optical signals. The combined phase and amplitude modulation performed by the SLM structure components 124a and 124b enable the modulated optical output signals to be generated. In some implementations, the SLM structure component 124b (e.g., the amplitude SLM) includes a transmissive phase-only SLM combined with one or more polarizers.

As indicated above, FIG. 5 is provided as an example. Other examples may differ from what is described with regard to FIG. 5.

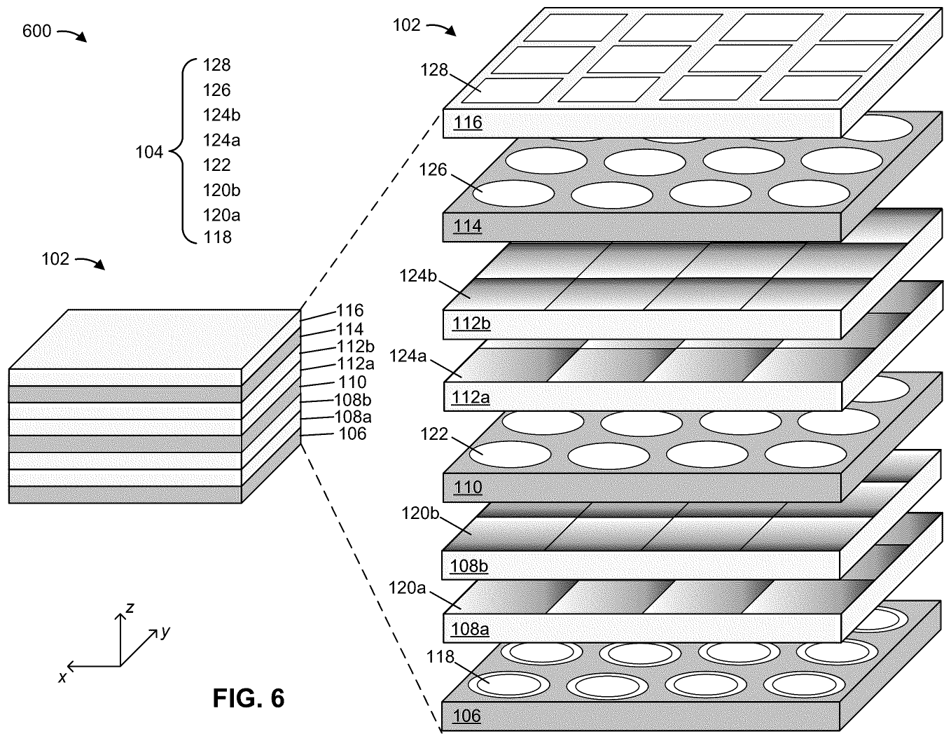

FIG. 6 is a diagram of example 600 of a semiconductor photonics device 102 that includes a photonic integrated circuit 104 described herein. FIG. 6 illustrates a perspective view of the example 600 of semiconductor photonics device 102 and an associated exploded view of the semiconductor photonics device 102 in which the details of the layers of the semiconductor photonics device 102 are illustrated. The photonic integrated circuit 104 includes a portion of an artificial neural network such as a CNN. The photonic integrated circuit 104 may be configured to perform a convolution operation for the CNN. The convolution operation may include a Fourier transform operation, a multiplication operation, and an inverse Fourier operation.

As shown in FIG. 6, in the example 600, the semiconductor photonics device 102 includes a layer stack similar to the example 100 in FIG. 1, except that the semiconductor photonics device 102 includes a plurality of SLM layers 108a and 108b between the light source layer 106 and the lens layer 110 in the z-direction, and a plurality of SLM layers 112a and 112b between the lens layer 110 and the lens layer 114 in the z-direction. Accordingly, the photonic integrated circuit 104 includes a plurality of SLM structure components 120a and 120b between the light source structure(s) 118 and the lens structure 122 in the z-direction and a plurality of SLM structure components 124a and 124b between the lens structure 122 and the lens structure 126 in the z-direction. The SLM structure component 120a may be adjacent to the light source structure(s) 118 in the z-direction, and the SLM structure component 120b may be adjacent to the lens structure 122 in the z-direction. The SLM structure component 124a may be adjacent to the lens structure 122 in the z-direction, and the SLM structure component 124b may be adjacent to the lens structure 126 in the z-direction.

The SLM structure components 120a and 120b may be configured to perform respective functions for modulating the optical input signals received from the light source structure(s) 118. For example, the SLM structure component 120a may include a transmissive phase-only SLM structure that is configured to perform phase modulation of the optical input signals, and the SLM structure component 120b may include a transmissive amplitude SLM (e.g., an amplitude modulation SLM structure component) configured to perform amplitude modulation of the optical input signals. The combined phase and amplitude modulation performed by the SLM structure components 120a and 120b enable the modulated optical input signals to be generated.

The SLM structure components 124a and 124b may be configured to perform respective functions for modulating the transformed optical signals received from the lens structure 122. For example, the SLM structure component 124a may include a transmissive phase-only SLM structure that is configured to perform phase modulation of the transformed optical signals, and the SLM structure component 124b may include a transmissive amplitude SLM (e.g., an amplitude modulation SLM structure component) configured to perform amplitude modulation of the transformed optical signals. The combined phase and amplitude modulation performed by the SLM structure components 124a and 124b enable the modulated optical output signals to be generated.

As indicated above, FIG. 6 is provided as an example. Other examples may differ from what is described with regard to FIG. 6.

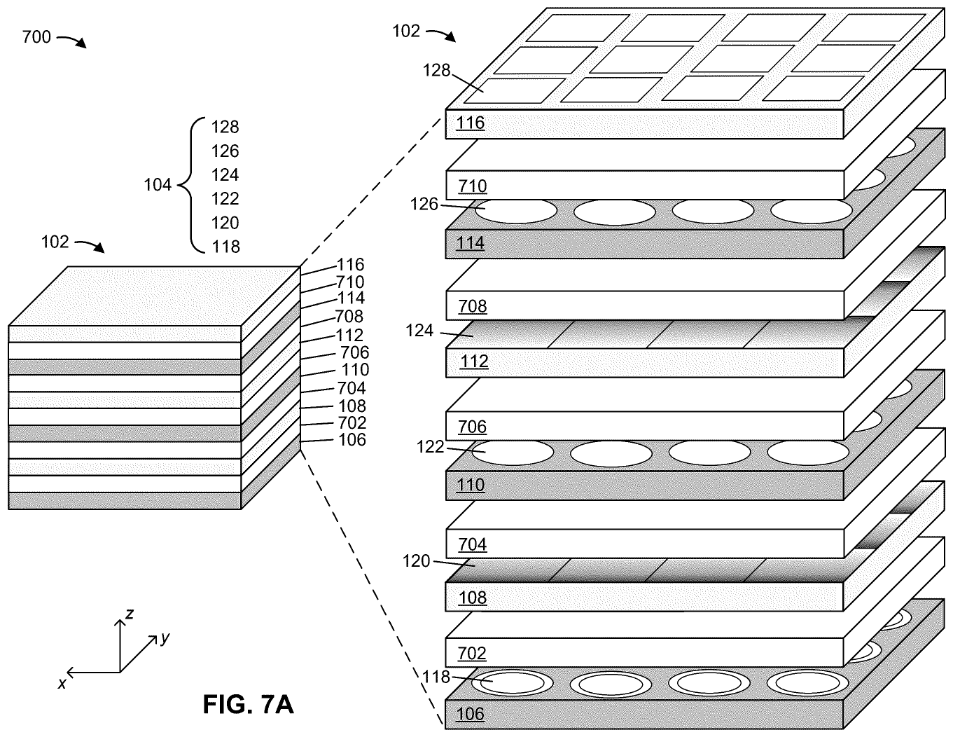

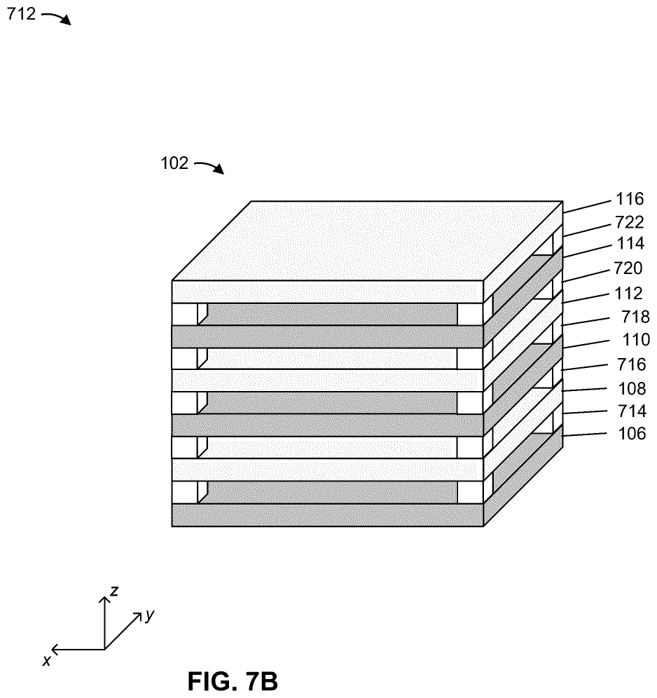

FIGS. 7A and 7B are diagrams of examples of a semiconductor photonics device 102 that includes a photonic integrated circuit 104 described herein. FIG. 7A illustrates a perspective view of an example 700 of a semiconductor photonics device 102 and an associated exploded view of the semiconductor photonics device 102 in which the details of the layers of the semiconductor photonics device 102 are illustrated. The photonic integrated circuit 104 includes a portion of an artificial neural network such as a CNN. The photonic integrated circuit 104 may be configured to perform a convolution operation for the CNN. The convolution operation may include a Fourier transform operation, a multiplication operation, and an inverse Fourier operation.

As shown in FIG. 7A, in the example 700, the semiconductor photonics device 102 includes a layer stack similar to the example 100 in FIG. 1, except that the semiconductor photonics device 102 includes one or more spacer layers 702, 704, 706, 708, and/or 710. Each spacer layer 702-710 includes a layer of optically transparent material such as silicon oxide (SiOₓ), glass, USG, and/or another type optically transparent material. Each spacer layer 702-710 may be included between two layers of the semiconductor photonics device 102 in the z-direction. For example, the spacer layer 702 may be included vertically between (e.g., in the z-direction) the light source layer 106 and the SLM layer 108, the spacer layer 704 may be included vertically between (e.g., in the z-direction) may be included between the SLM layer 108 and the lens layer 110, the spacer layer 706 may be included vertically between (e.g., in the z-direction) the lens layer 110 and the SLM layer 112, the spacer layer 708 may be included vertically between (e.g., in the z-direction) the SLM layer 112 and the lens layer 114, and/or the spacer layer 710 may be included vertically between (e.g., in the z-direction) the lens layer 114 and the photodetector layer 116.

In some implementations, the semiconductor photonics device 102 includes a greater quantity of spacer layers than the quantity illustrated in FIG. 7A. In some implementations, the semiconductor photonics device 102 includes few spacer layers than the quantity illustrated in FIG. 7A. In some implementations, the semiconductor photonics device 102 includes a different arrangement of spacer layers than the quantity illustrated in FIG. 7A.

The spacer layer(s) 702-710 may be included to enable the focal distances f1-f4, described in connection with FIGS. 2A and 2B, between components of the photonic integrated circuit 104 to be achieved. For example, the spacer layer 702 between the SLM layer 108 and the light source layer 106 and/or the spacer layer 704 between the SLM layer 108 and the lens layer 110 may enable the SLM structure 120 and the lens structure 122 of the photonic integrated circuit 104 to be spaced apart in the z-direction by the focal distance f1. The thickness of the spacer layer 702 and/or the thickness of the spacer layer 704 may be selected to achieve the focal distance f1. As another example, the spacer layer 706 between the lens layer 110 and the SLM layer 112 may enable the SLM structure 124 and the lens structure 122 of the photonic integrated circuit 104 to be spaced apart in the z-direction by the focal distance f2. The thickness of the spacer layer 706 between the lens layer 110 and the SLM layer 112 may be selected to achieve the focal distance f2.

As another example, the spacer layer 708 between the SLM layer 112 and the lens layer 114 may enable the SLM structure 124 and the lens structure 126 of the photonic integrated circuit 104 to be spaced apart in the z-direction by the focal distance f3. The thickness of the spacer layer 708 between the SLM layer 112 and the lens layer 114 may be selected to achieve the focal distance f3. As another example, the spacer layer 710 between the lens layer 114 and the photodetector layer 116 may enable the lens structure 126 and the photodetector structures 128 of the photonic integrated circuit 104 to be spaced apart in the z-direction by the focal distance f4. The thickness of the spacer layer 710 between the lens layer 114 and the photodetector layer 116 may be selected to achieve the focal distance f4.

In some implementations, the spacer layers 702, 704, 706, 708, and 710 each have approximately the same thickness. In some implementations, two or more of the spacer layers 702, 704, 706, 708, and/or 710 have different thicknesses.

FIG. 7B illustrates a perspective view of an example 712 of a semiconductor photonics device 102. The example 712 of the semiconductor photonics device 102 is similar to the example 700 of the semiconductor photonics device 102, except that spacer inserts 714, 716, 718, 720, and/or 722 are included between vertically adjacent layers of the semiconductor photonics device 102 instead of one or more spacer layers 702, 704, 706, 708. For example, the spacer inserts 714 may be included vertically between (e.g., in the z-direction) the light source layer 106 and the SLM layer 108, the spacer inserts 716 may be included vertically between (e.g., in the z-direction) may be included between the SLM layer 108 and the lens layer 110, the spacer inserts 718 may be included vertically between (e.g., in the z-direction) the lens layer 110 and the SLM layer 112, the spacer inserts 720 may be included vertically between (e.g., in the z-direction) the SLM layer 112 and the lens layer 114, and/or the spacer inserts 722 may be included vertically between (e.g., in the z-direction) the lens layer 114 and the photodetector layer 116. The spacer inserts 714, 716, 718, 720, and/or 722 may be located at corners of the layers of the layer stack so that the spacer inserts 714, 716, 718, 720, and/or 722 do not obstruct the optical transmission path of the photonics integrated circuit 104.

In some implementations, the semiconductor photonics device 102 includes a greater quantity of spacer inserts than the quantity illustrated in FIG. 7B. In some implementations, the semiconductor photonics device 102 includes few spacer inserts than the quantity illustrated in FIG. 7B. In some implementations, the semiconductor photonics device 102 includes a different arrangement of spacer inserts than the quantity illustrated in FIG. 7B. In some implementations, the spacer inserts 714, 716, 718, 722, and 722 each have approximately the same thickness. In some implementations, two or more of the inserts 714, 716, 718, 720, and/or 722 have different thicknesses.

As indicated above, FIGS. 7A and 7B are provided as examples. Other examples may differ from what is described with regard to FIGS. 7A and 7B.

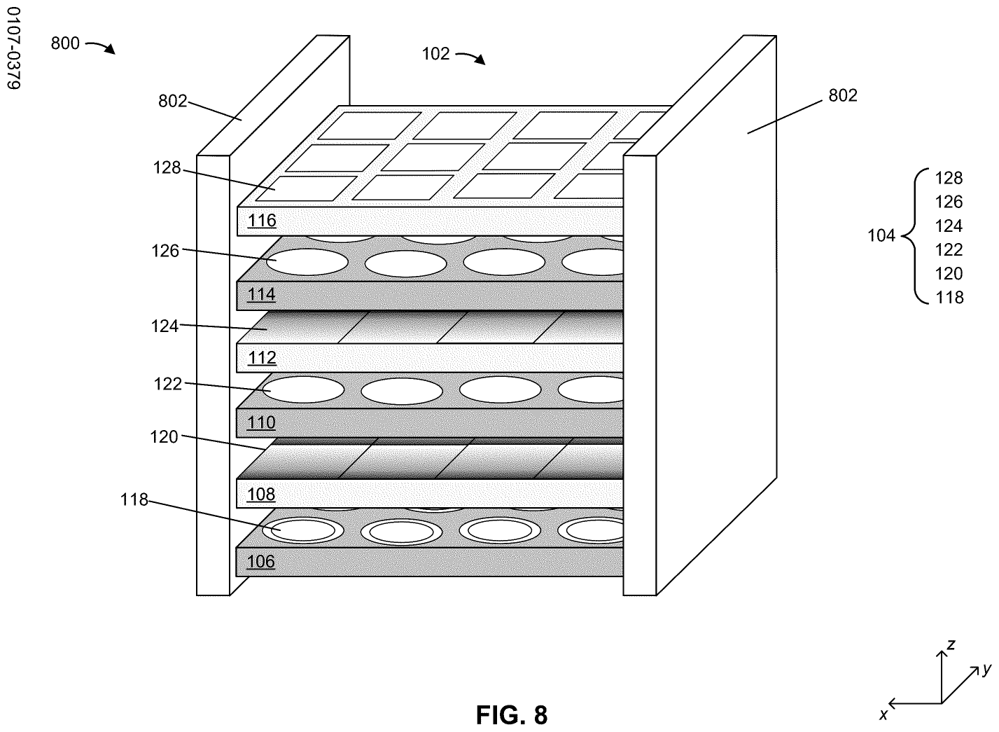

FIG. 8 is a diagram of example 800 of a semiconductor photonic device 102 that includes a photonic integrated circuit 104 described herein. FIG. 8 illustrates a perspective view of the example 800 of semiconductor photonics device 102 and an associated exploded view of the semiconductor photonics device 102 in which the details of the layers of the semiconductor photonics device 102 are illustrated. The photonic integrated circuit 104 includes a portion of an artificial neural network such as a CNN. The photonic integrated circuit 104 may be configured to perform a convolution operation for the CNN. The convolution operation may include a Fourier transform operation, a multiplication operation, and an inverse Fourier operation.

As shown in FIG. 8, in the example 800, the semiconductor photonic device 102 includes a layer stack similar to the example 100 in FIG. 1, except that one or more of layers of the semiconductor photonics device 102 are coupled with a movable rack 802. The movable rack 802 may be used to move one or more of the light source layer 106, the SLM layer 108, the lens layer 110, the SLM layer 112, the lens layer 114, and/or the photodetector layer 116 to be moved the z-direction in the semiconductor photonics device 102. Thus, the movable rack 802 enables the focal distances f1-f4, described in connection with FIGS. 2A and 2B, between components of the photonic integrated circuit 104 to be selected and/or modified. For example, the moveable rack 802 may be used to enable the SLM structure 120 and the lens structure 122 of the photonic integrated circuit 104 to be spaced apart in the z-direction by the focal distance f1, and/or may be used to tune or modify the focal distance f1. The movable rack 802 may enable the SLM layer 108 to be moved relative to the lens layer 110 and/or the lens layer 110 to be moved relative to the SLM layer 108 to select a particular focal distance f1. As another example, the moveable rack 802 may be used to enable the SLM structure 124 and the lens structure 122 of the photonic integrated circuit 104 to be spaced apart in the z-direction by the focal distance f2, and/or may be used to tune or modify the focal distance f2. The movable rack 802 may enable the SLM layer 112 to be moved relative to the lens layer 110 and/or the lens layer 110 to be moved relative to the SLM layer 112 to select a particular focal distance f2.

As another example, the moveable rack 802 may be used to enable the SLM structure 120 and the lens structure 126 of the photonic integrated circuit 104 to be spaced apart in the z-direction by the focal distance f3, and/or may be used to tune or modify the focal distance f3. The movable rack 802 may enable the SLM layer 112 to be moved relative to the lens layer 114 and/or the lens layer 114 to be moved relative to the SLM layer 112 to select a particular focal distance f3. As another example, the moveable rack 802 may be used to enable the photodetector structures 128 and the lens structure 124 of the photonic integrated circuit 104 to be spaced apart in the z-direction by the focal distance f4, and/or may be used to tune or modify the focal distance f4. The movable rack 802 may enable the photodetector layer 116 to be moved relative to the lens layer 114 and/or the lens layer 114 to be moved relative to the photodetector layer 116 to select a particular focal distance f4.

In some implementations, the light source layer 106, the SLM layer 108, the lens layer 110, the SLM layer 112, the lens layer 114, and/or the photodetector layer 116 to be supported by the movable rack 802 at opposing ends. In some implementations, the light source layer 106, the SLM layer 108, the lens layer 110, the SLM layer 112, the lens layer 114, and/or the photodetector layer 116 may be supported by the movable rack 802 at bottoms of the light source layer 106, the SLM layer 108, the lens layer 110, the SLM layer 112, the lens layer 114, and/or the photodetector layer 116.

As indicated above, FIG. 8 is provided as an example. Other examples may differ from what is described with regard to FIG. 8.

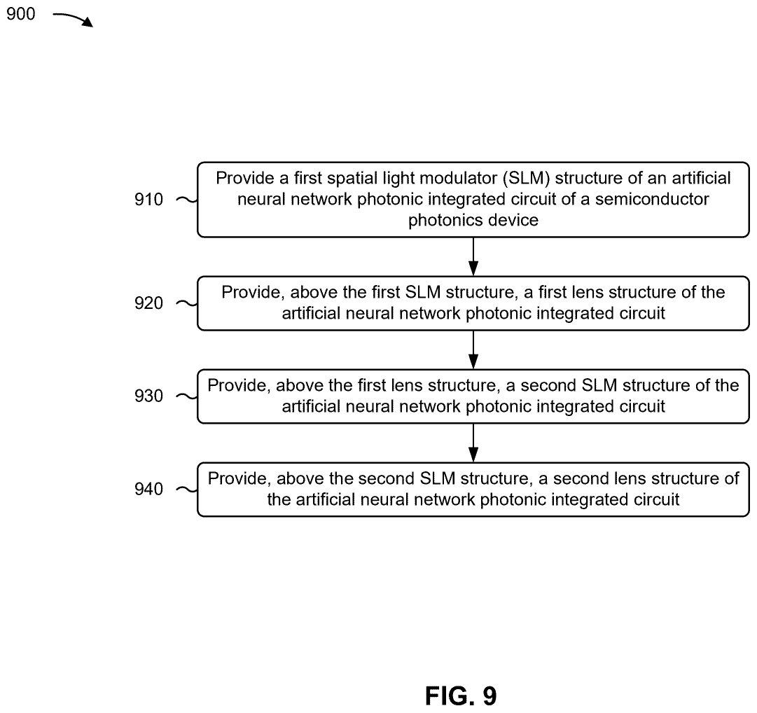

FIG. 9 is a flowchart of an example process 900 associated with forming a photonic integrated circuit of a semiconductor photonics device described herein. In some implementations, one or more process blocks of FIG. 9 are performed using one or more semiconductor processing tools, such as a deposition tool, an exposure tool, a developer tool, an etch tool, a plating tool, a planarization tool, an ion implantation tool, a pick and place tool, a wafer/die transport tool, and/or another type of semiconductor processing tool.

As shown in FIG. 9, process 900 may include providing a first SLM structure of an artificial neural network photonic integrated circuit of the semiconductor photonics device (block 910). For example, one or more semiconductor processing tools may be used to provide an SLM structure 120 of an artificial neural network photonic integrated circuit (e.g., a photonic integrated circuit 104) of a semiconductor photonics device 102, as described herein. In some implementations, the SLM structure 120 may be placed above a substrate.

As further shown in FIG. 9, process 900 may include providing, above the first SLM structure, a first lens structure of the artificial neural network photonic integrated circuit (block 920). For example, one or more semiconductor processing tools may be used to provide, above the SLM structure 120, a lens structure 122 of the artificial neural network photonic integrated circuit, as described herein.

As further shown in FIG. 9, process 900 may include providing, above the first lens structure, a second SLM structure of the artificial neural network photonic integrated circuit (block 930). For example, one or more semiconductor processing tools may be used to provide, above the lens structure 122, an SLM structure 124 of the artificial neural network photonic integrated circuit, as described herein. In some implementations, the lens structure 122 is between the SLM structure 120 and a SLM structure 124.

As further shown in FIG. 9, process 900 may include providing, above the substrate, a second lens structure of the artificial neural network photonic integrated circuit (block 940). For example, one or more semiconductor processing tools may be used to provide, above the SLM structure 124, a lens structure 126 of the artificial neural network photonic integrated circuit, as described herein.

Process 900 may include additional implementations, such as any single

implementation or any combination of implementations described below and/or in connection with one or more other processes described elsewhere herein.

In a first implementation, the first SLM structure 120, the first lens structure 122, the second SLM structure 124, and the second lens structure 126 are vertically arranged or vertically stacked in the semiconductor photonics device 102.

In a second implementation, alone or in combination with the first implementation, providing the first lens structure 122 includes providing the first lens structure 122 on an optically transparent substrate of a lens layer 110.

In a third implementation, alone or in combination with one or more of the first or second implementations, providing the first SLM structure 120 includes providing a first plurality of SLM structures 120, where the first plurality of SLM structures are included on separate optically transparent substrates.

In a fourth implementation, alone or in combination with one or more of the first through third implementations, providing the first plurality of SLM structures 120 includes providing a phase-only SLM structure component 120a and providing an amplitude SLM structure component 120b.

In a fifth implementation, alone or in combination with one or more of the first through fourth implementations, process 900 includes providing one or more coherent light source structures (e.g., light source structures 118, 120a, 120b) such that the one or more coherent light source structures are adjacent to the first SLM structure 120, and providing one or more photodetector structures (e.g., photodetector structures 128, 128a, 128b) such that the one or more photodetector structures are adjacent to the second lens structure 126.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

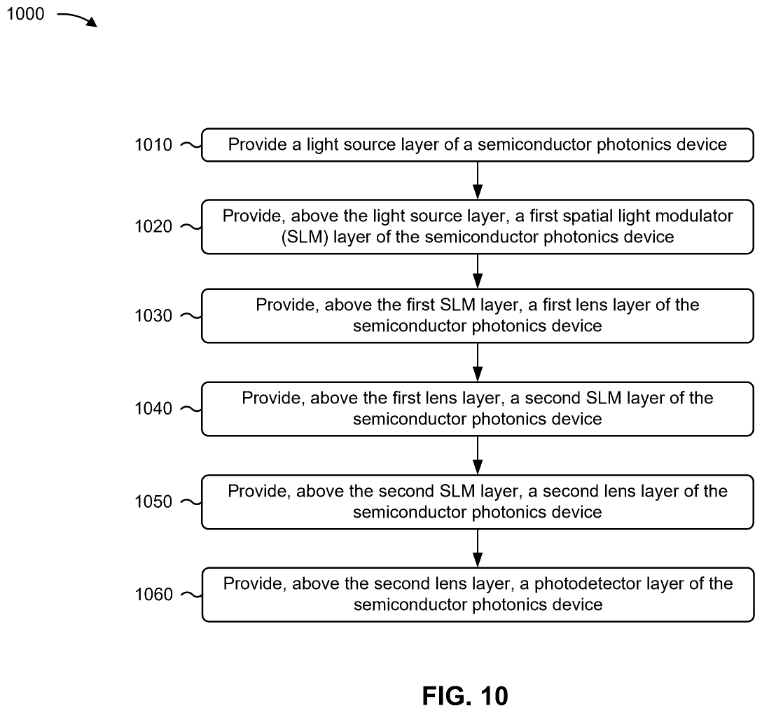

FIG. 10 is a flowchart of an example process 1000 associated with forming a semiconductor photonics device described herein. In some implementations, one or more process blocks of FIG. 10 are performed using one or more semiconductor processing tools, such as a deposition tool, an exposure tool, a developer tool, an etch tool, a plating tool, a planarization tool, an ion implantation tool, a pick and place tool, a wafer/die transport tool, and/or another type of semiconductor processing tool.

As further shown in FIG. 10, process 1000 may include providing a light source layer of the semiconductor photonics device (block 1010). For example, one or more semiconductor processing tools may be used to provide a light source layer 106 of a semiconductor photonics device 102, as described herein. In some implementations, the light source layer 106 may be placed above a substrate.

As further shown in FIG. 10, process 1000 may include providing, above the light source layer, a first SLM layer of the semiconductor photonics device (block 1020). For example, one or more semiconductor processing tools may be used to provide, an SLM layer 108 above the light source layer 106 of the semiconductor photonics device 102, as described herein. In some implementations, a spacer layer 702 is provided on the light source layer 106, and the SLM layer 108 is provided on the spacer layer 702.

As further shown in FIG. 10, process 1000 may include providing, above the first SLM layer, a first lens layer of the semiconductor photonics device (block 1030). For example, one or more semiconductor processing tools may be used to provide, above the SLM layer 108, a lens layer 110 of the semiconductor photonics device 102, as described herein. In some implementations, a spacer layer 704 is provided on the SLM layer 108, and the lens layer 110 is provided on the spacer layer 704.

As further shown in FIG. 10, process 1000 may include providing, above the first lens layer, a second SLM layer of the semiconductor photonics device (block 1040). For example, one or more semiconductor processing tools may be used to provide, above the lens layer 110, an SLM layer 112 of the semiconductor photonics device 102, as described herein. In some implementations, a spacer layer 706 is provided on the lens layer 110, and the SLM layer 112 is provided on the spacer layer 706.

As further shown in FIG. 10, process 1000 may include providing, above the second SLM layer, a second lens layer of the semiconductor photonics device (block 1050). For example, one or more semiconductor processing tools may be used to provide, above the SLM layer 112, a lens layer 114 of the semiconductor photonics device 102, as described herein. In some implementations, a spacer layer 708 is provided on the SLM layer 112, and the lens layer 114 is provided on the spacer layer 708.

As further shown in FIG. 10, process 1000 may include providing, above the second lens layer, a photodetector layer of the semiconductor photonics device (block 1060). For example, one or more semiconductor processing tools may be used to provide, above the lens layer 114, a photodetector layer 106 of the semiconductor photonics device 102, as described herein. In some implementations, a spacer layer 710 is provided on the lens layer 114, and the photodetector layer 116 is provided on the spacer layer 710.

Process 1000 may include additional implementations, such as any single implementation or any combination of implementations described below and/or in connection with one or more other processes described elsewhere herein.

In a first implementation, the SLM layer 108, the lens layer 110, the SLM layer 112, and the lens layer 114 are vertically arranged in the semiconductor photonics device 102.

In a second implementation, alone or in combination with the first implementation, providing the SLM layer 108 includes providing a first SLM layer 108a and providing a second SLM layer 108b on the first SLM layer 108a.

In a third implementation, alone or in combination with one or more of the first or second implementations, providing the SLM layer 112 includes providing a first SLM layer 112a and providing a second SLM layer 112b on the first SLM layer 112a.

Although FIG. 10 shows example blocks of process 1000, in some implementations, process 1000 includes additional blocks, fewer blocks, different blocks, or differently arranged blocks than those depicted in FIG. 10. Additionally, or alternatively, two or more of the blocks of process 1000 may be performed in parallel.

In this way, semiconductor photonics devices described herein include three-dimensional photonic integrated circuits that include optical components configured to implement an artificial neural network such as a CNN or a portion thereof. For example, a semiconductor photonics device described herein may include a three-dimensional photonic integrated circuit that includes optical lens structures and SLM structures that are arranged to perform the sub-operations of a convolution operation, including a Fourier transform operation, a multiplication operation, and an inverse Fourier transform operation. The three-dimensional photonic integrated circuits described herein enable the use of photons to implement encoded optical signals that may be passively transformed for performing complex artificial intelligence tasks. Thus, the photonic integrated circuits described herein consume significantly less power and may be less complex electronic integrated circuits, thereby enabling further scaling of artificial neural networks.

As described in greater detail above, some implementations described herein provide a semiconductor photonics device. The semiconductor photonics device includes a photonic integrated circuit that includes a first SLM structure, a first lens structure, a second SLM structure, and a second lens structure. The first lens structure is between the first SLM structure and the second SLM structure, and the second SLM structure is between the first lens structure and the second lens structure.

As described in greater detail above, some implementations described herein provide a semiconductor photonics device. The semiconductor photonics device includes a first SLM layer that includes one or more first SLM structures, a first lens layer that includes one or more first lens structures, a second SLM layer that includes one or more second SLM structures, and a second lens layer that includes one or more second lens structures. The first lens layer is between the first SLM layer and the second SLM layer, and the second SLM layer is between the first lens layer and the second lens layer.

As described in greater detail above, some implementations described herein provide a method. The method includes providing a first SLM structure of an artificial neural network photonic integrated circuit of a semiconductor photonics device. The method includes providing, above the first SLM structure, a first lens structure of the artificial neural network photonic integrated circuit. The method includes providing, above the first lens structure, a second SLM structure of the artificial neural network photonic integrated circuit, where the first lens structure is between the first SLM structure and the second SLM structure. The method includes providing, above the second SLM structure, a second lens structure of the artificial neural network photonic integrated circuit, where the second SLM structure is between the first lens structure and the second lens structure.

The terms “approximately” and “substantially” can indicate a value of a given quantity that varies within 5% of the value (e.g., +1%, +2%, +3%, +4%, +5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a first spatial light modulator (SLM) structure;
a first lens structure;
a second SLM structure,
wherein the first lens structure is between the first SLM structure and the second SLM structure; and
a second lens structure,
wherein the second SLM structure is between the first lens structure and the second lens structure.

2. The semiconductor photonics device of claim 1, wherein the first SLM structure comprises a transmissive SLM structure.

3. The semiconductor photonics device of claim 2, wherein the second SLM structure comprises another transmissive SLM structure.

4. The semiconductor photonics device of claim 1, wherein the first SLM structure comprises a plurality of SLM structure components; and
wherein the plurality of SLM structure components comprise:
a phase-only SLM structure component; and
an amplitude modulation SLM structure component.

5. The semiconductor photonics device of claim 4, wherein the second SLM structure comprises another plurality of SLM structure components; and
wherein the other plurality of SLM structure components comprise:
another phase-only SLM structure component; and
another amplitude modulation SLM structure component.
